(19) United States
(12) Patent Application Publication
(10) Pub. No.: US 2014/0000253 A1
(43) Pub. Date: Jan. 2, 2014

(54) PNEUMATIC WINDING MECHANISM FOR A TIMEPIECE COMPRISING A MECHANICAL ENERGY SOURCE

(71) Applicant: Association Suisse Pour La Recherche Horlogere, Nuechatel (CH)

(72) Inventor: Dominique Perreux, Pirey (FR)

(73) Assignee: ASSOCIATION SUISSE POUR LA RECHERCHE HORLOGERE, Neuchatel (CH)

(21) Appl. No.: 13/923,271

(22) Filed: Jun. 20, 2013

Related U.S. Application Data
(63) Continuation of application No. PCT/EP2011/072980, filed on Dec. 15, 2011.

(30) Foreign Application Priority Data
Dec. 21, 2010 (EP) EP10196325.4

(51) Int. Cl. F03G 7/00

(52) U.S. Cl. CPC F03G 7/00
USPC 60/528

(57) ABSTRACT

A pneumatic mechanism for a timepiece, is disclosed, which comprises a mechanical energy source, the pneumatic mechanism being arranged to recharge the mechanical energy source, and comprising a sealed chamber capable of alternately expanding and contracting in volume as a function of variations in the surrounding temperature. The sealed chamber may contain a mixture of reactants comprising a metal alloy arranged in contact with a gas and capable of undergoing at least one phase change as a function of variations in the surrounding temperature. The mixture of reactants advantageously has a coefficient ΔP/ΔT substantially higher than about 0.01 bar·° C.⁻¹ and with operating ranges between about 0 and about 50° C. in temperature and between about 1 and about 50 bar in pressure. Furthermore, the minimum possible difference between temperatures associated with consecutive contrariwise variations in the surrounding temperature may be smaller than or equal to about 4° C.

This application is a continuation application of prior International Application No. PCT/EP2011/072980, filed Dec. 15, 2011 and claiming priority to European (EP) Patent Application No. 10196325.4, filed Dec. 21, 2010. The disclosures of the above-referenced applications are expressly incorporated herein by reference to their entireties.

### TECHNICAL FIELD

The present disclosure relates to a pneumatic mechanism for a timepiece that may comprise a mechanical energy source. More particularly, and without limitation, the present disclosure relates to a pneumatic mechanism that is arranged so as to recharge the energy source, such as a mechanical energy source of a timepiece, and comprises a sealed chamber capable of alternately expanding and contracting in volume as a function of variations in the surrounding temperature.

The present disclosure also relates to a timepiece comprising such a pneumatic mechanism arranged so as to recharge a mechanical energy source of the timepiece.

### BACKGROUND

Timepieces with a mechanical energy source are already known from the prior art. For example, Jaeger-LeCoultre has sold, for many years, a clock, under the Atmos trade mark, having a mechanical energy source that is recharged from deformations undergone by a sealed capsule filled with a fluid, as a function of variations in the surrounding temperature.

The basic principle of this clock is, for example, described in patents CH 198355 or CH 199527.

However, it will be noted that such a pneumatic mechanism has never been employed in other sorts of timepieces, especially in wristwatches, because the required modifications pose size-related problems.

Patent applications JP 2003-028049 and JP 2003-120514 disclose devices for producing mechanical energy from variations in ambient temperature. In particular they make use of the phase changes of pastes, mainly composed of paraffins, to produce mechanical energy from the thermal energy associated with the temperature variations. Additives are listed that allow the temperature of the phase change of the paste to be adjusted depending on the specific requirements of the user, for example by modifying a composition based on a given paraffin.

However, with the phase changes provided by these documents, i.e. between liquid and solid phases, only mechanical movements of small amplitudes can be generated. Therefore, a conversion mechanism that would allow these movements to be usefully exploited would necessarily have a complex structure, unsuitable for implementation in a timepiece.

### SUMMARY

The present disclosure improves on known prior-art mechanisms and the above challenges by providing a pneumatic mechanism that is intended to recharge the mechanical energy source of a timepiece more efficiently that it becomes possible to incorporate it into a wristwatch.

The present disclosure more particularly relates to a pneumatic mechanism of the type mentioned above, wherein the sealed chamber contains a mixture of reactants that may comprise a metal alloy arranged in contact with a gas, the mixture being capable of undergoing at least one phase change as a function of variations in the surrounding temperature. Furthermore, the mixture of reactants may have a coefficient ΔP/ΔT substantially higher than about 0.01 bar·° C.−1 in the following operating ranges:
between about 0 and about 50° C. in temperature, and
between about 1 and about 50 bar in pressure.

Moreover, the mixture of reactants may be chosen so that the minimum possible difference between temperatures associated with consecutive contrariwise variations in the surrounding temperature is substantially smaller than or equal to about 4° C.

By virtue of these features, the pneumatic mechanism according to the present disclosure may be used as an energy source supplying energy to a secondary, preferably mechanical, energy source, whatever the size of the corresponding timepiece. Specifically, the nature of the physical effect driving the pneumatic mechanism according to the present disclosure makes it possible for this mechanism to be produced with a smaller bulk than in the prior art. Specifically, the pneumatic mechanism of the present disclosure may be smaller than the mechanisms of the Japanese applications cited above, as these applications do not disclose modification of the proportion of a reactive gas in a sealed chamber.

Preferably, the mechanism according to the present disclosure may comprise a metal alloy that reacts with dihydrogen or dideuterium in order to form a metal hydride alloy. More particularly, the metal alloy may have the general formula AB₅ in which A is a metal or a mixture of metals and B is a metal or a mixture of metals. A may comprise at least one element chosen from the group comprising Ce, La, Nd and Pr. B may comprise at least one element chosen from the group comprising Co, Ni and Sn.

More precisely, the metal alloy may be chosen from the group comprising (La, Ce)(Ni, Co)5, (La, Ce)(Ni, Co)5+ε and (La, Ce)(Ni, Sn)5+ε, where ε may be between about 0 and about 0.2, for example.

By virtue of these features, the pressure variations obtained in the sealed chamber, as a function of variations in the surrounding temperature, may allow sufficient energy to be supplied to the mechanical energy source of the corresponding timepiece.

According to particular embodiments, the coefficient ΔP/ΔT may be higher than about 0.05 bar·° C.−1, and higher than about 0.1 bar·° C.−1, in the following operating ranges:
between about 15 and about 40° C. in temperature, and between about 15 and about 30° C. in temperature, and/or
between about 1 and about 20 bar in pressure, and between about 1 and about 10 bar.

Furthermore, the minimum possible difference between the temperatures associated with consecutive contrary variations in the surrounding temperature may preferably be smaller than about 2° C., and smaller than about 1° C.

By virtue of these features, the pneumatic mechanism according to the disclosure may have properties that are suitable for the common conditions of use for timepieces, generally.

Moreover, the sealed chamber may advantageously be configured in such a way that the variations in its volume are associated with its deformation, or with the movement of a moveable element such as a piston, in a single direction, in order to optimize the work done by this deformation or movement.

The disclosure also relates to a timepiece that may comprise a pneumatic mechanism such as described above, and further comprising a conversion system associated, at least indirectly, on the one hand, with the sealed chamber and, on the other hand, with the mechanical energy source, so as to recharge the latter from variations in the volume of the sealed chamber.

### BRIEF DESCRIPTION OF THE DRAWINGS

Other features and advantages of the present disclosure will become more clearly apparent on reading the following detailed description, given with reference to the appended drawings, which are provided by way of non-limiting examples, and in which:

FIG. 1 shows a block diagram illustrating the principle of the present disclosure;

FIG. 2 shows a phase diagram allowing the principle of the present disclosure to be demonstrated;

FIG. 3 shows a graph illustrating van't Hoff relationships for a selection of compounds;

FIG. 4a shows a first graph illustrating the results of experimental measurements;

FIG. 4b shows a second diagram illustrating the results of additional experimental measurements;

FIG. 4c shows a third diagram illustrating the results of additional experimental measurements;

FIG. 5 shows a schematic of a perspective view of a first exemplary embodiment of a pneumatic mechanism according to the disclosure, in a wristwatch; and

FIG. 6 shows a schematic of a perspective view of a second exemplary embodiment of a pneumatic mechanism according to the disclosure, in a wristwatch.

### DETAILED DESCRIPTION OF THE EMBODIMENTS

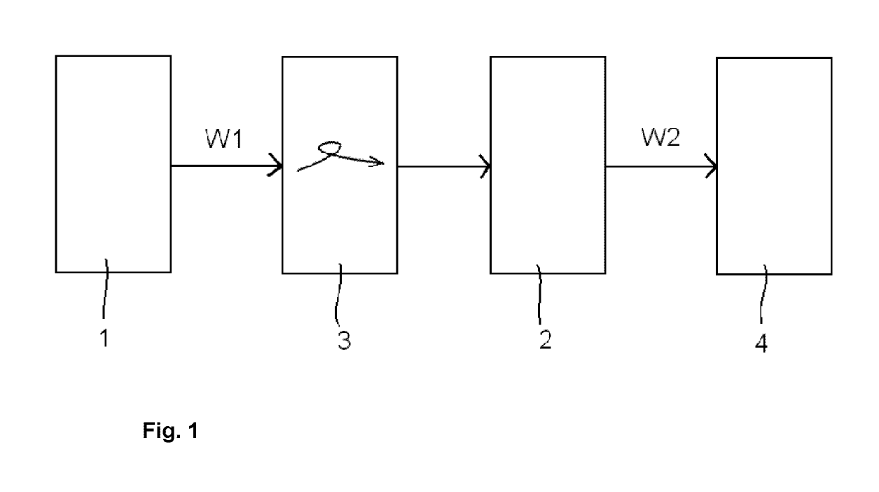

FIG. 1 shows a block diagram illustrating the general principles of the present disclosure.

According to an embodiment of the present invention, the pneumatic winding mechanism may comprise a primary energy source 1 allowing a secondary energy source 2 to be recharged by way of a conversion mechanism 3, the secondary energy source may be arranged in order to supply a clock movement 4 with mechanical energy.

Advantageously, the primary energy source 1 may comprise a sealed chamber that is capable of alternately expanding and contracting in volume as a function of contrariwise variations in the surrounding temperature. More particularly, a sealed chamber may contain a mixture of reactants, comprising a metal alloy arranged in contact with a gas. The mixture may be capable of undergoing at least one phase change as a function of variations in the surrounding temperature via a reaction between the metal alloy and the gas, wherein the phase change may have an impact on the amount of gas present in the sealed chamber and therefore on the volume of the latter.

In order to guarantee that the winding mechanism is highly effective under common timepiece operating conditions, the mixture of reactants may have a coefficient ΔP/ΔT that is substantially higher than about 0.01 bar·° C.−1 in the following operating ranges:
between about 0 and about 50° C. in temperature, and
between about 1 and about 50 bar in pressure,
and is chosen so that the minimum possible difference between temperatures, in said sealed chamber, associated with consecutive contrariwise variations in the surrounding temperature, is substantially smaller than or equal to about 4° C., smaller than about 2° C., or smaller than about 1° C.

For example, an increase in the temperature of the mixture of reactants, in a first step, followed, in a second step, by a decrease of about 4° C. from the maximum temperature reached during the increase, may cause respective contrary phase changes. These changes may occur substantially at the respective temperature levels, which levels differ from each other by about 4° C. at most.

Such a feature may guaranty that the system will react to the temperature variations most commonly experienced by a timepiece in the context of its standard use.

Statistical measurements with regard to variations in the surrounding temperature experienced, in particular, by a wristwatch have been measured. It is clear from these measurements that negative or positive relative variations in temperature by as much as about 4° C. may occur in significant amounts. It is deduced therefrom that this value of 4° C. may reasonably be used as an effective limiting value for the difference between temperatures associated with consecutive contrariwise variations in surrounding temperature. Furthermore, about 2° C. and even about 1° C. may be used as this limiting value, in order to improve the sensitivity of the mechanism to variations in the surrounding temperature as temperature variations of about 1° C. or about 2° C. were found to occur more frequently than variations of about 4° C.

With regard to a compound to be selected, the limiting value must have a hysteresis with an amplitude substantially smaller than about 4° C. on a phase diagram, wherein the phase diagram relates to a temperature increase and a temperature decrease, respectively.

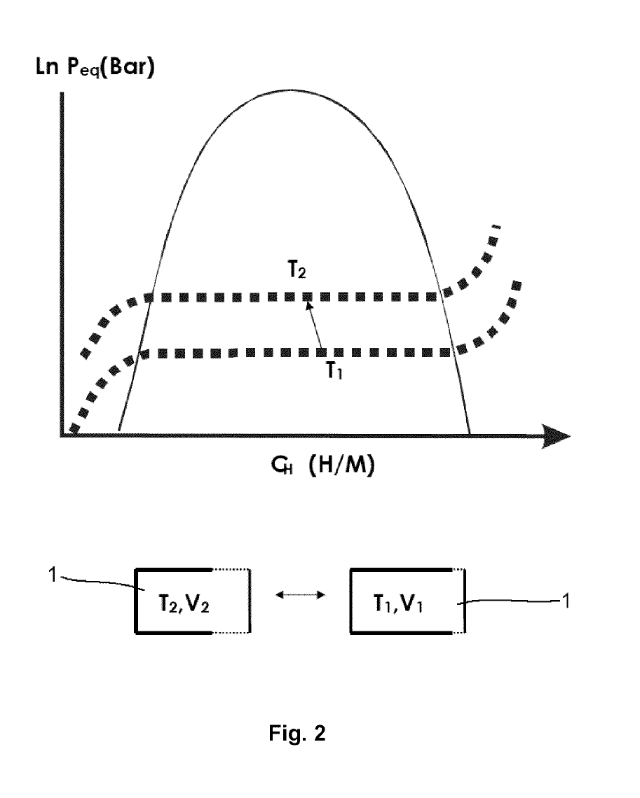

The phase diagram shown in FIG. 2 illustrates the behavior of a mixture of reactants meeting certain criteria that are well known in the art and that will not be described in greater detail here.

More precisely, this diagram shows the percentage of dihydrogen in the mixture of reactants as a function of temperature T and of pressure P. In particular, FIG. 2 illustrates the behavior of a mixture of reactants comprising a metal hydride alloy and dihydrogen.

Hydrogen may react with many transition metals to form hydrides. The transition may include, for example, lanthanides. Many of these metals or the corresponding intermetallics (M) may form a hydride (MHₙ) having a stoichiometry that differs greatly from the stoichiometric formula (n=1, 2, etc.), and may form multiphase systems.

The intermetallics may further be as an ABₙ compound.

In the presence of hydrogen (for example dihydrogen or dideuterium) the metals or intermetallics may form hydrides. The corresponding reaction to form the hydrides may be accompanied with the release of heat. The reaction, which may be associated with a phase change, as shown in equilibrium:

M+nH2 [symbol] MH2n+Q; or

α-phase+nH2 [symbol] β-phase+Q.

The conditions of this equilibrium may be set by the dihydrogen pressure and the surrounding temperature.

As shown in FIG. 2, for a given temperature, the phase change results in a transformation plateau, which may be relatively flat depending on the nature of the alloy in question. By way of nonlimiting example, it will be noted that LaNi₅ has a plateau of this type.

It can be demonstrated that there is a relationship, called the van't Hoff relationship, between the pressure of the plateau and inverse temperature:

$$Log ( {P}_{Plateau} ) = \frac{Δ H}{RT} - \frac{Δ S}{R}$$

where ΔH and ΔS are the enthalpy of formation and entropy, respectively, and depend on the compound considered.

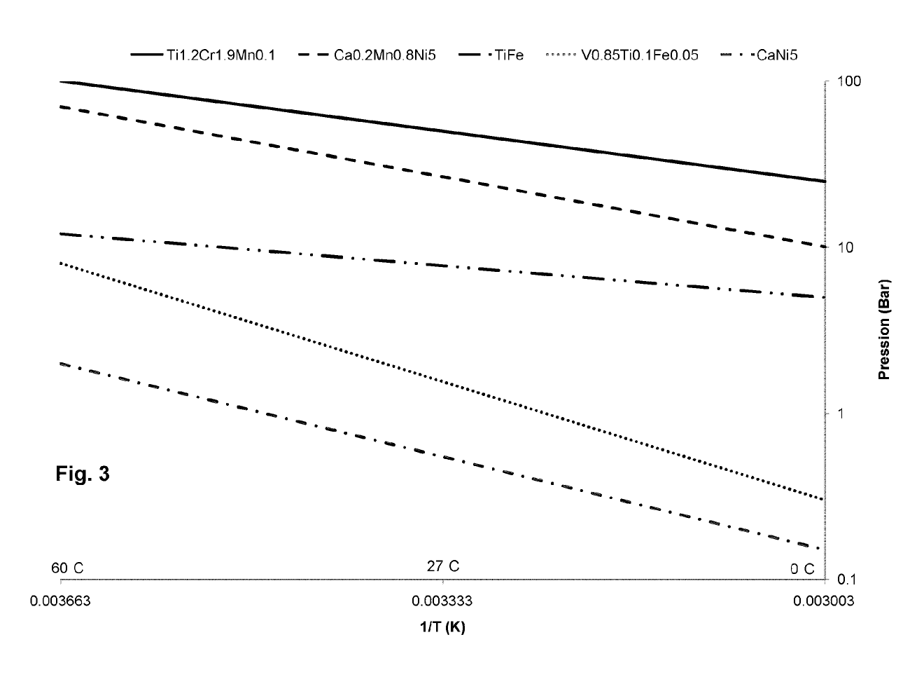

There are many metal hydrides having different enthalpies of formation and entropies, and, as is shown in FIG. 3, which illustrates the van't Hoff relationship for a particular selection of metal compounds, of the metal hydrides are configured to work in different temperature ranges.

The aforementioned plateau pressure may be used to do mechanical work, which may allow the mechanical energy source of a timepiece to be recharged.

Specifically, if a mixture of reactants comprising a metal hydride alloy and dihydrogen at a given temperature and in equilibrium is placed in a sealed chamber, the volume of which can vary, the hydrogen pressure (when it is higher than the surrounding pressure) has a tendency to increase the volume of the chamber. At the same time, the pressure inside the chamber has a tendency to decrease. To maintain the equilibrium of the system, the phase change may be activated, and the metal hydride alloy may release hydrogen in order to increase the pressure in the chamber and return the system to equilibrium.

Similarly, a variation in the surrounding temperature may modify the equilibrium of the system and may modify the volume of the sealed chamber by changing its internal pressure. Thus the present disclosure employs a mixture of reactants placed in a chamber, the volume of which can vary, in order to make use of variations in the surrounding temperature.

It will be noted that, without departing from the scope of the present disclosure, the pneumatic mechanism may be arranged so that only variations in the volume of the sealed chamber in a single direction, i.e. only volume increases or volume decreases, or in both directions, are exploited.

By way of example, FIG. 2 shows the behavior of a sealed chamber subjected to a temperature variation of T1 to T2, wherein T2 is higher than T1. The increase in temperature causes the pressure to increase in the chamber. The volume of the chamber may increase if it can deform and, substantially simultaneously, the proportion of dihydrogen in the mixture of reactants may decrease.

It will be noted that the variation in the volume of the sealed chamber may take two forms of different natures, both being suitable for use in the present disclosure. Specifically, the volume of the chamber may vary via deformation of at least part of its wall or, alternatively, via the movement of a moveable part, such as a piston.

The mixture of reactants used in the present disclosure may be chosen such that two consecutive phase changes, associated with an increase and with a decrease in the surrounding temperature, respectively, take place when the mixture of reactants is at respective temperatures, the minimum possible difference between these temperatures being smaller than a given limiting value. If the latter condition is met, the system may function substantially reversibly. For example, the smaller the difference between the respective temperatures associated with two consecutive contrariwise variations in the surrounding temperature, the more sensitive the system may be to variations in the surrounding temperature. Careful choice of this parameter therefore may allow the operation of the pneumatic mechanism according to the disclosure to be improved by making it more sensitive to variations in the surrounding temperature.

Thus, classes of compounds that would be suitable for producing a pneumatic winding mechanism of the type just described have been identified.

More precisely, apart from the above condition, compounds suitable for implementing such a mechanism must operate in a temperature range around room temperature and deliver a pressure of about a few bar at this temperature.

In addition, the pressure variation induced by a given temperature variation must be sufficiently large to cause a significant variation in the volume of the sealed chamber. This is a necessary condition when a satisfactory amount of mechanical work is to be done. In other words, the ratio ΔP/ΔT must preferably be higher than a certain threshold, such as mentioned above.

Specific classes of compounds may satisfactorily meet the requirement of allowing sufficient mechanical work to be done by the mechanism.

For this purpose, various experimental measurements were carried out with the aim of evaluating the mechanical work that can be obtained from a sealed chamber of variable volume and containing a mixture of reactants of the aforementioned type.

In a first step, a metal hydride alloy having an operating range around room temperature and delivering a pressure of a few bar at this temperature was selected for the tests. The LaNi₅ family is suitable for these conditions, and the tests were carried out with an LaNi_{4.8}Al_{0.2} compound, the aluminum increasing the lifetime of the alloy in terms of the number of cycles it can withstand, and allowing the equilibrium pressure to be adjusted.

Starting in an equilibrium situation, the mixture of reactants was subjected to a variation in the surrounding temperature, and the pressure in the container was measured, at constant volume. Measurements were carried out in a temperature range comparable to the actual conditions of use of a wristwatch, namely ±3° C. about an average temperature of 28° C.

On the whole, a variation in pressure of about 0.1 bar was observed for a variation in temperature of about 1° C.

Additional experimental measurements were carried out with a spring mounted on the cylinder of a piston and a force meter, with the aim of evaluating the mechanical work that can be done by a system such as described above.

By changing the surrounding temperature, the adsorption or desorption of hydrogen with respect to the metal alloy was promoted. This had the effect of decreasing or increasing the pressure, and therefore the force exerted on the cylinder. Furthermore, this caused deformation of the spring, which was made to move and exert a force. The movement and force of the spring was measured.

Generally, the mechanical work done on the spring by the mixture of reactants was calculated using the equation: dW=F·dx, where F is the force and x is the position of the moveable end of the spring. Therefore, dx is an incremental movement and dW the corresponding incremental amount of mechanical work.

The results of the measurements made it possible to demonstrate the validity of following relationships:

F=k(x+l0); and

P=at+b.

In these equations, x is measured from an arbitrary position in which the spring has already deformed in length by an amount l₀, k being the stiffness of the spring used, and t the temperature of the surroundings.

In addition it is necessary to consider that the force is related to the pressure by the equation:

F=P·S,

S being the cross section of the piston.

An expression for the force is thus obtained, namely:

F=k(x+l1)=S(at+b).

The following expression for mechanical work can be deduced therefrom:

$$dW = S ( at + b ) \frac{Sa}{k} dt .$$

Thus for a variation in the surrounding temperature between T₀ and T₁, the mechanical work:

$$W ( {T}_{0} \to {T}_{1} ) = {\int }_{{T}_{0}}^{{r}_{1}} S ( at + b ) \frac{Sa}{k} d t = \frac{{S}^{2} {a}^{2}}{2 k} ( {T}_{1}^{2} - {T}_{0}^{2} ) + \frac{{S}^{2} ba}{k} ( {T}_{1} - {T}_{0} )$$

is done.

Introducing the temperature variation ΔT0=T1−T0, it is deduced that:

$$W ( {T}_{0} \to {T}_{0} + Δ {T}_{0} ) = \frac{{S}^{2} {a}^{2}}{2 k} ( Δ {T}_{0}^{2} + 2 {T}_{0} Δ {T}_{0} ) + \frac{{S}^{2} ba}{k} Δ {T}_{0} .$$

If a complete expansion/contraction cycle is considered, the above expression for the work done becomes:

W(T₀→T₀+ΔT₀)+W(T₀+ΔT₀→T₀)=0

since, in the case of the measurement device used, the spring does work on the cylinder during the decrease in the surrounding temperature.

This is because the mixture of reactants together with the spring are equivalent to a closed thermodynamic system that only exchanges energy internally. Therefore, in the return phase of the cycle, it is the spring that does work.

Of course, pneumatic systems may be envisioned that supply energy in both directions of the cycle, but, in the rest of the study, only one direction was investigated with the aim of evaluating the amount of energy available, for example the direction where ΔT₀>0.

If such a mechanism were placed in a timepiece and were set up to do work only when the surrounding temperature varied in one direction, the energy that it would supply in one week may be expressed as follows:

$$W = W ( {T}_{0} \to {T}_{0} + Δ T = {T}_{1} ) + W ( {T}_{1} \to {T}_{1} + Δ {T}_{1} = {T}_{2} ) + … = \vert \frac{{S}^{2} {a}^{2}}{2 k} ( Δ {T}_{0}^{2} + 2 {T}_{0} Δ {T}_{0} ) + \frac{{S}^{2} ba}{k} Δ {T}_{0} \vert + \vert \frac{{S}^{2} {a}^{2}}{2 k} ( Δ {T}_{1}^{2} + 2 {T}_{1} Δ {T}_{1} ) + \frac{{S}^{2} ba}{k} Δ {T}_{1} \vert + …$$

Considering the even increments ΔT₀, ΔT₂, . . . to be positive and the odd increments ΔT₁, ΔT₃, . . . to be negative, the following relationship is obtained:

$$W = {\sum }_{i = 0}^{i = N} [ \frac{{S}^{2} {a}^{2}}{2 k} ( Δ {T}_{2 i}^{2} + 2 {T}_{2 i} Δ {T}_{2 i} ) + \frac{{S}^{2} ba}{k} Δ {T}_{2 i} ]$$

where N is the number of surrounding temperature change events in a week.

If, in a first example, it is assumed that T₂ᵢ=T_{average} for any value of i, then:

$$W = {\sum }_{i = 0}^{i = N} [ \frac{{S}^{2} {a}^{2}}{2 k} ( Δ {T}_{2 i}^{2} + 2 {T}_{average} Δ {T}_{2 i} ) + \frac{{S}^{2} ba}{k} ( Δ {T}_{2 i} ) ] .$$

It is possible, in the first example, to consider the average surrounding temperature to be 28° C. If the statistical measurements regarding temperature variations carried out are input into the above relationship, the total energy produced in a week is found to be about 67 joules, which is much greater than the energy required by a wristwatch, for example, which may be estimated to be about 1 joule per week.

Of course, although the order of magnitude of this result indicates that the pneumatic mechanism tested is suitable for incorporation into a timepiece such as a clock, it would need to be modified to be incorporated into a wristwatch.

It can be seen from the above analysis that the energy supplied is proportional to the area of exchange between the various parts of the mechanism, and that overall the energy that the mixture of reactants delivers to the system takes the form:

$$w \sim f ( {R}^{2} , d , \frac{1}{K} , {T}_{average} , Δ T )$$

where R is a characteristic quantity of the system (for example, in the preceding system, especially the diameter of the piston), d represents a movement (for example, in the preceding system, the movement of the spring), K represents a stiffness to be overcome (for example that of a spring to be recharged), whereas T_{average} and ΔT depend on the thermal history of the timepiece.

It is clearly apparent from the above that the work done is highly dependent on the quantity ΔP/ΔT (a² being included in R²), as mentioned above.

Additional measurements may be carried out in order to identify metal compounds that could be suitable for use in the present disclosure.

In a first step, about twenty compositions belonging to several classes of compounds of formula AB₅, AB₂, AB, etc. were synthesized and examined with regard to their hydrogenation properties. The compounds used contained metal constituents chosen from the group comprising, for A, metal alloys based on Ce, La, Zr, Ti and Mg, and for B, on Ni, Fe, Co, Mn, Al, Sn, Si and Ge.

Measurements of hydrogen pressure were carried out as a function of temperature, at constant volume, in temperature and pressure ranges compatible with the application in question. Following these measurements, it became clear than the compositions with the best properties in terms of hydrogenation (ΔP/ΔT and small temperature hysteresis) were those of formula AB₅.

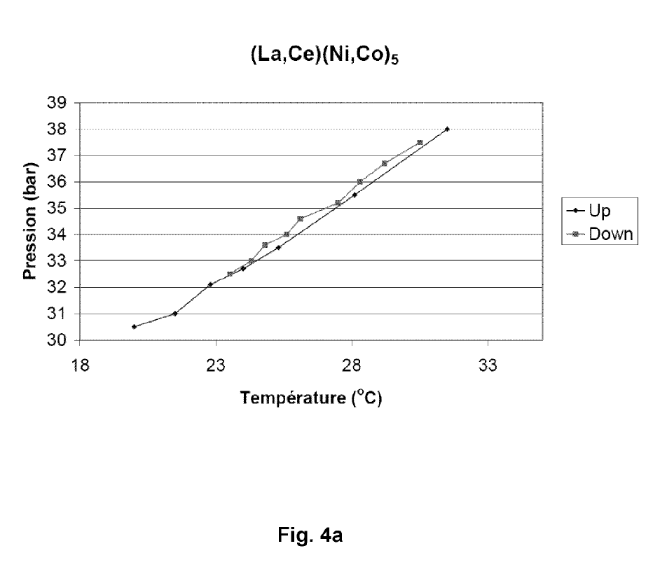

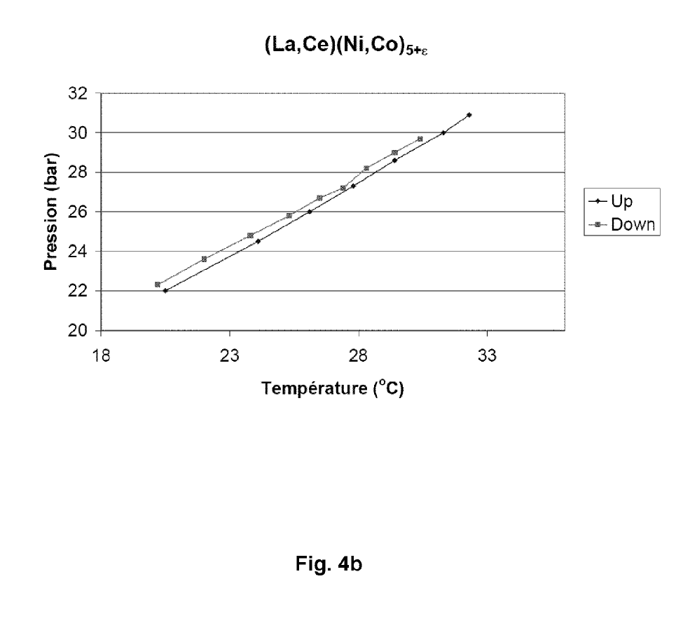

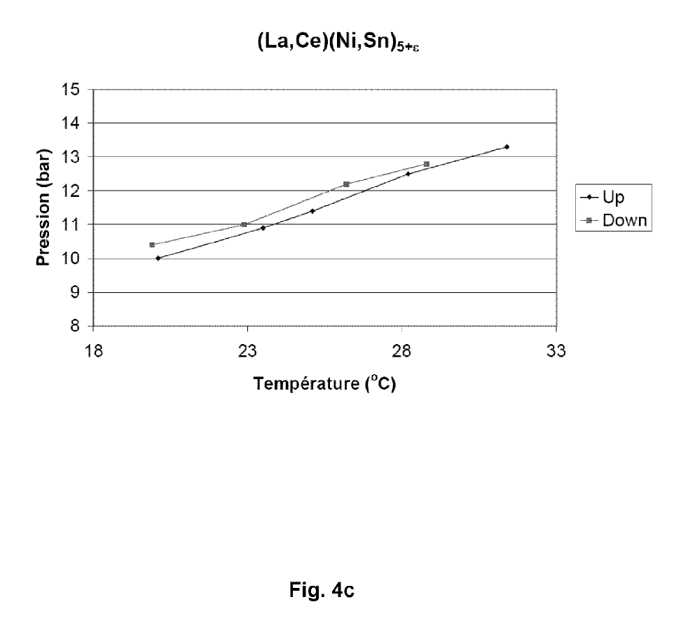

The properties of three compositions having properties suitable for implementation of the invention are illustrated in FIGS. 4a, 4b and 4c and collated in the table below, by way of non-limiting example (in the table ε lies substantially between 0 and 0.2, by way of non-limiting example).

| Material | Pressure | Temperature | ΔP/ΔT | Hysteresis |
|---|---|---|---|---|
| No. 1: | 30-38 bar | 20-32° C. | ~0.7 bar/ | <0.5° C. |
| (La, Ce)(Ni, Co)₅ | | | ° C. | |
| No. 2: | 22-31 bar | 20-32° C. | ~0.7 bar/ | <0.5° C. |
| (La, Ce)(Ni, Co)_{5+ε} | | | ° C. | |
| No. 3: | 10-13 bar | 20-31° C. | ~0.3 bar/ | <0.5° C. |
| (La, Ce)(Ni, Sn)_{5+ε} | | | ° C. | |

It will be noted that the differential values ΔP/ΔT shown here are minimum values observed for a given free volume specific to the measuring system used. If the measuring system were optimized such that a smaller free volume was used, a larger differential would result.

Additional measurements, which a person skilled in the art would have no difficulty in performing, were carried out in order to evaluate the forces and deformations that such an alloy, when placed in a container of small volume (about 0.2 cm³) making contact with a deformable sealed body, is able to provide when the container is subjected to thermal cycles corresponding to successive periods of heating and cooling by about ten degrees (between about 20 and 30° C.). These measurements were carried out with two variant measurement systems, causing, on the one hand, deformation of a bellows, and on the other hand, deformation of an elastic membrane.

The forces and deformations measured in this way for the three alloys described above, may allow for various calculations. For example calculations based on, on the one hand, the experimental results (in combination with the method disclosed above regarding the calculation of the work done), and on the other hand, statistical data characterizing the temperature variation cycles that a watch is subjected to during its use (an estimate of the energy obtained during one week of operation).

These calculations returned the estimations given in the table below:

| Material | Weekly nergy | Conversion system |
|---|---|---|
| No. 1: | 7.2 J | membrane |
| (La, Ce)(Ni, Co)₅ | | |
| No. 2: | 5.3 J | membrane |
| (La, Ce)(Ni, Co)_{5+ε} | | |
| No. 3: | 0.6 J | bellows |
| (La, Ce)(Ni, Sn)_{5+ε} | | |

It will be noted that these are indicative values. Specifically, the value calculated for the energy may depend on the values measured for the forces and movements. Additionally, these measured values may depend on the particular geometry of the measurement system used. The above energy values are therefore given by way of non-limiting example; however, these values nonetheless demonstrate that the pneumatic mechanisms described may be used to wind the mechanical energy source of a timepiece. In particular, as described above, these mechanisms are suitable for use in winding the mainspring of a wristwatch, which requires the supply of about 1 joule per week, for a basic model.

It will be noted that, with regards the implementation of a pneumatic mechanism, such as those described above in relation to a timepiece application, it is advantageous to reduce the moveable areas in order to take account of the high pressures that may be applied.

It is furthermore preferable for the moveable element to undergo a large movement under a small force, so as to optimize the mechanical work done. Thus, it will be advantageous to use a structure, for the sealed chamber, that deforms in only one dimension.

In the case where the pneumatic mechanism must function in both possible directions in which the surrounding temperature can vary, it may be advantageous to design said mechanism to operate about the most statistically probable equilibrium temperature.

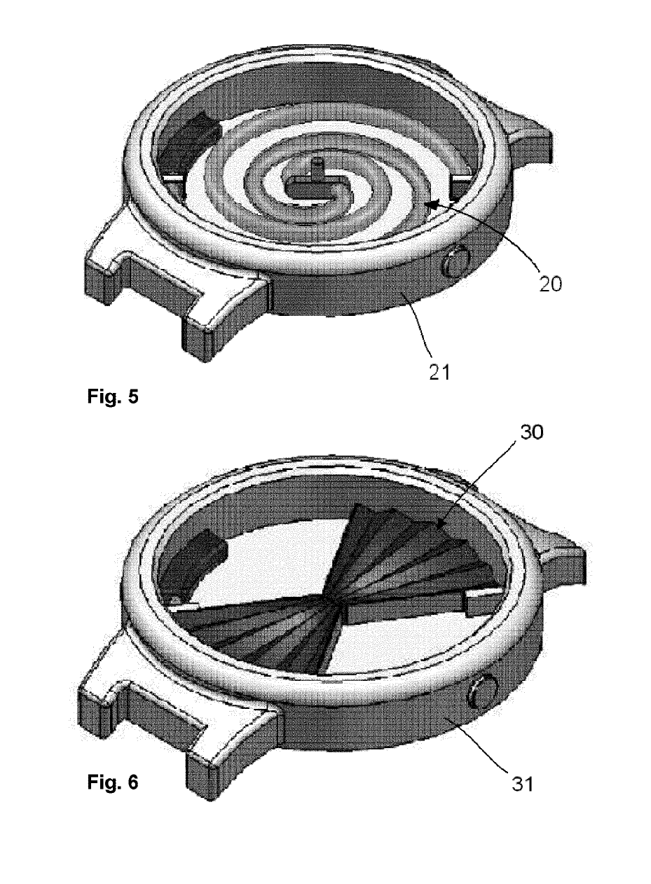

FIG. 5 illustrates a first embodiment of such a pneumatic mechanism in a wristwatch.

The arrangement of FIG. 5 may use a hermetic chamber 20 having a generally spiral shape, the length of which can vary as a function of its internal pressure, and placed at the bottom of a watch housing 21. The mixture of reactants, comprising a metal hydride alloy and dihydrogen, may be placed in sealed chamber 20. Additionally, the length of chamber 20 may vary as a function of the surrounding temperature.

By way of example, it is possible for a moveable end of sealed chamber 20 to be securely fastened to a rack (not shown), or to an optionally curved or toothed rail, wherein the rack/rail is arranged so as to engage with a gear of a winding mechanism of a clock movement.

In the case where the mainspring is wound only in a single direction of variation of the surrounding temperature, a one-way transmission ratchet may be arranged between this gear and the mainspring. In the case where winding must take place in both directions of variation of the surrounding temperature, a reverser may be arranged between this gear and the mainspring.

FIG. 6 illustrates a second example of an arrangement of a pneumatic mechanism according to the invention in a wristwatch.

Similarly to the arrangement in FIG. 5, the mechanism in FIG. 6 makes use of a sealed chamber 30 taking the general form of a double-chambered bellows, the central angle of which may vary depending on its internal pressure, and being placed in the bottom of a watch case 31. The mixture of reactants may be placed in this sealed chamber, the angular opening of which may thereby vary as a function of the surrounding temperature, leading to a movement of its side walls. This movement may then be employed to do work by means of a suitable conversion mechanism, such as the aforementioned, for example.

The above description was describes particular embodiments by way of non-limiting illustration, and the disclosure is not limited to implementation of the particular features described herein, such as, for example, the compounds for which measurements were mentioned. Specifically, other compounds may meet the requirements and be employed in a pneumatic mechanism for winding the mechanical energy source of a timepiece, without departing from the scope of the present invention. It is contemplated to use other metal alloys, provided a phase change is involved in the operation of the pneumatic mechanism, so as to achieve a suitably large ΔP/ΔT value. Likewise, the production methods described are non-limiting and are given merely by way of example.

It will be noted that, when it is applied to a wristwatch, the pneumatic mechanism according to the invention may comprise a chamber the volume of which is smaller than 5 cm³, for example smaller than 2 cm³.

The one skilled in the art should have no particular difficulty modifying the contents of the present disclosure to its own requirements and should be perfectly able to produce a pneumatic winding mechanism having some of the features described above without departing from the scope of the present invention. In particular, it will be noted that the requirements with regard to the relevant parameters were given as relatively wide value ranges, in particular because the conditions to be met differ greatly depending on whether the timepiece to be produced is a clock or a wristwatch.

What is claimed is:

1. A pneumatic mechanism for a timepiece comprising a mechanical energy source, said mechanism being arranged to recharge said mechanical energy source, and comprising a sealed chamber capable of alternately expanding and contracting in volume as a function of variations in the surrounding temperature,
said sealed chamber containing a mixture of reactants comprising a metal alloy arranged in contact with a gas, said mixture being capable of undergoing at least one phase change as a function of variations in the surrounding temperature via reaction between said metal alloy and said gas,
said mixture of reactants having a coefficient ΔP/ΔT greater than 0.01 bar·° C.⁻¹ in the following operating ranges:
between about 0 and about 50° C. in temperature, and
between about 1 and about 50 bar in pressure,
and being chosen so that the minimum possible difference between temperatures, in said sealed chamber, associated, respectively, with consecutive contrariwise variations in the surrounding temperature, is smaller than or equal to about 4° C.

2. The pneumatic mechanism of claim 1, wherein said metal alloy is a metal hydride alloy, said gas being dihydrogen or dideuterium.

3. The pneumatic mechanism of claim 2, wherein said metal hydride alloy has a general formula AB₅, in which A is a metal or a mixture of metals and B is a metal or a mixture of metals.

4. The pneumatic mechanism of claim 3, wherein A comprises at least one element chosen from the group comprising Ce, La, Nd and Pr.

5. The pneumatic mechanism of claim 3, wherein B comprises at least one element chosen from the group comprising Co, Ni, and Sn.

6. The pneumatic mechanism of claim 3, wherein said metal alloy is chosen from the group comprising (La, Ce)(Ni, Co)₅, (La, Ce)(Ni, Co)_{5+ε} and (La, Ce)(Ni, Sn)_{5+ε}.

7. The pneumatic mechanism of claim 1, wherein said coefficient ΔP/ΔT is greater than about 0.01 bar·° C.⁻¹ in an operating range of temperature between about 15 and about 40° C.

8. The pneumatic mechanism of claim 1, wherein said coefficient ΔP/ΔT is greater than about 0.01 bar·° C.⁻¹ in an operating range of pressure between about 1 and about 20 bar.

9. The pneumatic mechanism of claim 1, wherein said coefficient ΔP/ΔT is greater than about 0.05 bar·° C.⁻¹.

10. The pneumatic mechanism of claim 1, wherein said minimum possible difference between the temperatures associated with consecutive contrariwise variations in the surrounding temperature is smaller than about 2° C.

11. The pneumatic mechanism of claim 1, wherein said sealed chamber is configured to deform in a single direction to give rise to volume variations.

12. A timepiece comprising a pneumatic mechanism as claimed in claim 1, further comprising a conversion system associated, at least indirectly, on the one hand, with said sealed chamber and, on the other hand, with said mechanical energy source, so as to recharge said mechanical energy source from variations in the volume of said sealed chamber.

13. The pneumatic mechanism of claim 4, wherein B comprises at least one element chosen from the group comprising Co, Ni, and Sn.

14. The pneumatic mechanism of claim 13, wherein said coefficient LIP/AT is greater than about 0.01 bar·° C.⁻¹ in an operating range of temperature between about 15 and about 40° C.

15. The pneumatic mechanism of claim 14, wherein said coefficient ΔP/ΔT is greater than about 0.01 bar·° C.⁻¹ in an operating range of pressure between about 1 and about 20 bar.

16. The pneumatic mechanism of claim 15, wherein said coefficient ΔP/ΔT is greater than about 0.05 bar·° C.⁻¹.

17. A timepiece comprising a pneumatic mechanism according to claim 2, further comprising a conversion system associated, at least indirectly, on the one hand, with said sealed chamber and, on the other hand, with said mechanical energy source, so as to recharge said mechanical energy source from variations in the volume of said sealed chamber.

18. A timepiece comprising a pneumatic mechanism according to claim 3, further comprising a conversion system associated, at least indirectly, on the one hand, with said sealed chamber and, on the other hand, with said mechanical energy source, so as to recharge said mechanical energy source from variations in the volume of said sealed chamber.

19. A timepiece comprising a pneumatic mechanism according to claim 13, further comprising a conversion system associated, at least indirectly, on the one hand, with said sealed chamber and, on the other hand, with said mechanical energy source, so as to recharge said mechanical energy source from variations in the volume of said sealed chamber.

20. A timepiece comprising a pneumatic mechanism according to claim 16, further comprising a conversion system associated, at least indirectly, on the one hand, with said sealed chamber and, on the other hand, with said mechanical energy source, so as to recharge said mechanical energy source from variations in the volume of said sealed chamber.
